(19) United States
(12) Patent Application Publication
(10) Pub. No.: US 2020/0409827 A1
(43) Pub. Date: Dec. 31, 2020

(54) METHOD AND SYSTEM FOR AUTOMATING GENERATION OF TEST DATA AND ASSOCIATED CONFIGURATION DATA FOR TESTING

(71) Applicant: Wipro Limited, Bangalore (IN)

(72) Inventors: Gopinath Chenguttuvan, Annanur (IN); Vaishali Rajakumari T, Tondairpet (IN)

(21) Appl. No.: 16/541,198

(22) Filed: Aug. 15, 2019

(30) Foreign Application Priority Data
Jun. 28, 2019 (IN) 201941025954

(51) Int. Cl. G06F 11/36; G06F 11/34; G06K 9/62; G06N 3/08

(52) U.S. Cl. CPC G06F 11/3684; G06F 11/3419; G06N 3/08; G06K 9/6264; G06K 9/6257

(57) ABSTRACT

The present disclosure is related to field of testing, disclosing method and system for automating generation of test data and associated configuration data for testing. A test data generating system retrieves test requirement data from a test plan related to an Application Under Test and translates the test requirement data into plurality of vectors. Subsequently, each of the plurality of vectors are provided to a trained Artificial Neural Network (ANN) to identify context associated with the plurality of vectors based on probabilities generated for each vector. The probabilities are generated by the trained ANN using the input. Further, at least one automation module is selected from a plurality of automation modules stored in a database based on the context, which is then executed to generate test data and configuration data for testing. The present disclosure makes the process of generating test data and configuration data, fast, efficient, accurate and reliable.

### TECHNICAL FIELD

The present disclosure relates to the field of testing. Particularly, but not exclusively, the present disclosure relates to a neural network-based generation of test data and associated configuration data for testing.

### BACKGROUND

Generally, test data is an input data given at a time of execution to a program. The test data can be generated manually or by using an automated test data generation tool. Test configuration is a process of checking an application with different combinations of software and hardware to find out an optimal configuration. In the existing techniques, the test data and the test configuration are generated manually. However, manual activity may consume a lot of time. Moreover, in some cases, test scenarios may have to be configured with different data combinations for each region and product under test which consumes nearly 50% of overall test planning effort. Therefore, the situation demands shortening testing timelines and allocating more time for generation of the test data and the test configuration, thereby deteriorating the quality of testing.

Further, since, the existing techniques generate the test data and the test configuration manually, practically it may not be possible to generate the test data and the test configuration for large set of test cases every time. Due to this limitation, the applications may be tested with same test data and test configuration every time, which may not satisfy the test coverage.

Further, in some scenarios, it is necessary to pass real time data extracted from different applications to generate the test data for an Application Under Test (AUT). Currently, the data from different application is manually extracted and stored in a data repository, which is further used for generation of the test data. However, since the data extraction is performed manually, there exists a time gap in fetching the data, thereby failing to meet the requirement of fetching the data in real-time.

Few other existing techniques generate test data through Structured Query Language (SQL) queries. However, the test data which is generated through SQL queries may lead to incorrect test data generation, when details in the database tables are modified. Also, these types of existing techniques create dependency on development team to get the updated database table, which again slows down the test data generation process due to manual intervention.

The information disclosed in this background of the disclosure section is only for enhancement of understanding of the general background of the invention and should not be taken as an acknowledgement or any form of suggestion that this information forms the prior art already known to a person skilled in the art.

### SUMMARY

One or more shortcomings of the prior art are overcome, and additional advantages are provided through the provision of method of the present disclosure. Additional features and advantages are realized through the techniques of the present disclosure. Other embodiments and aspects of the disclosure are described in detail herein and are considered a part of the claimed disclosure.

Disclosed herein is a method of automating generation of test data and associated configuration data for testing. The method includes retrieving, by a test data generating system, a test requirement data from a test plan related to an Application Under Test (AUT). Further, the method includes translating the test requirement data into a plurality of vectors. Subsequently, the method includes providing each of the plurality of vectors as input to a trained Artificial Neural Network (ANN) to identify a context associated with the plurality of vectors based on a plurality of probabilities generated for each of the plurality of vectors. The plurality of probabilities is generated by the trained ANN using the input. Further, the method includes selecting at least one automation module from a plurality of automation modules stored in a database based on the context. Finally, the method includes executing the at least one automation module to generate test data and associated configuration data for testing.

Embodiments of the present disclosure disclose a test data generating system for automating generation of test data and associated configuration data for testing. The test data generating system comprises a processor and a memory communicatively coupled to the processor. The memory stores the processor-executable instructions, which, on execution, causes the processor to retrieve a test requirement data from a test plan related to an Application Under Test (AUT). Further, the processor is configured to translate the test requirement data into a plurality of vectors. Subsequently, the processor is configured to provide each of the plurality of vectors as input to a trained Artificial Neural Network (ANN) to identify a context associated with the plurality of vectors based on a plurality of probabilities generated for each of the plurality of vectors. The plurality of probabilities are generated by the trained ANN using the input. Further, the processor is configured to select at least one automation module from a plurality of automation modules stored in a database based on the context. Finally, the processor is configured to execute the at least one automation module to generate test data and associated configuration data for testing.

Further, the present disclosure comprises a non-transitory computer readable medium including instructions stored thereon that when processed by at least one processor causes a test data generating system to automate generation of test data and associated configuration data for testing to retrieve a test requirement data from a test plan related to an Application Under Test (AUT). Further, the instructions cause the processor to translate the test requirement data into a plurality of vectors. Subsequently, the instructions cause the processor to provide each of the plurality of vectors as input to a trained Artificial Neural Network (ANN) to identify a context associated with the plurality of vectors based on a plurality of probabilities generated for each of the plurality of vectors. The plurality of probabilities are generated by the trained ANN using the input. Further, the instructions cause the processor to select at least one automation module from a plurality of automation modules stored in a database based on the context. Finally, the instructions cause the processor to execute the at least one automation module to generate test data and associated configuration data for testing.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary architecture for automating generation of test data and associated configuration data for testing, in accordance with some embodiments of the present disclosure;

FIG. 2A shows a detailed block diagram of a test data generating system, in accordance with some embodiments of the present disclosure;

FIG. 2B shows an exemplary artificial neural network architecture with a vector as input, in accordance with some embodiments of the present disclosure;

FIG. 3 shows a flowchart illustrating method of automating generation of test data and associated configuration data for testing, in accordance with some embodiment of the present disclosure; and

FIG. 4 shows an exemplary computer system for automating generation of test data and associated configuration data for testing, in accordance with some embodiments of the present disclosure;

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

The present disclosure provides a method and a system for automating generation of test data and associated configuration data for testing. A test data generating system may retrieve a test requirement data from a test plan related to an Application Under Test (AUT). Further, the test data generating system may translate the test requirement data into a plurality of vectors. The test data generating system may provide each of the plurality of vectors as input to a trained Artificial Neural Network (ANN) module to identify a context associated with the plurality of vectors based on a plurality of probabilities generated for each of the plurality of vectors. In some embodiments, the plurality of probabilities is generated by the trained ANN using the input. Further, the test data generating system may select at least one automation module from a plurality of automation modules stored in a database based on the context. Upon selecting at least one automation module, the test data generating system may execute the at least one automation module to generate the test data and associated configuration data for testing.

Further, the test data generating system may provide the generated test data and the associated configuration data to an automation testing tool associated with the test data generating system for executing one or more test scenarios. Upon executing the one or more test scenarios, the test data generating system may monitor time taken for execution of the one or more test scenarios and validate performance corresponding to execution of the one or more test scenarios by comparing the time taken for execution of the one or more test scenarios with a predefined standard execution time.

The present disclosure enables automated generation of test data and test configuration based on the test requirement, by automatically selecting the automation module required for generating the test data and the test configuration. Automatic selection of the automation module eliminates the manual intervention in generation of the test data, thereby making the process of generating the test data and the test configuration fast, efficient, accurate and reliable. Further, since, the manual intervention is eliminated, the present disclosure enables generation of the test data and the test configuration for large set of test cases for every build, thereby ensuring higher test coverage and elimination of defect slippage. Further, the present disclosure generates a report based on the execution result which helps in improving the performance of the execution workflow. Since, the present disclosure uses trained ANNs for generating the test data and test configuration, it is possible to predict test data and configuration for new scenarios by correlating historic test data and test configuration, which was earlier not possible due to involvement of manual efforts for generation of the test data and the test configuration.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

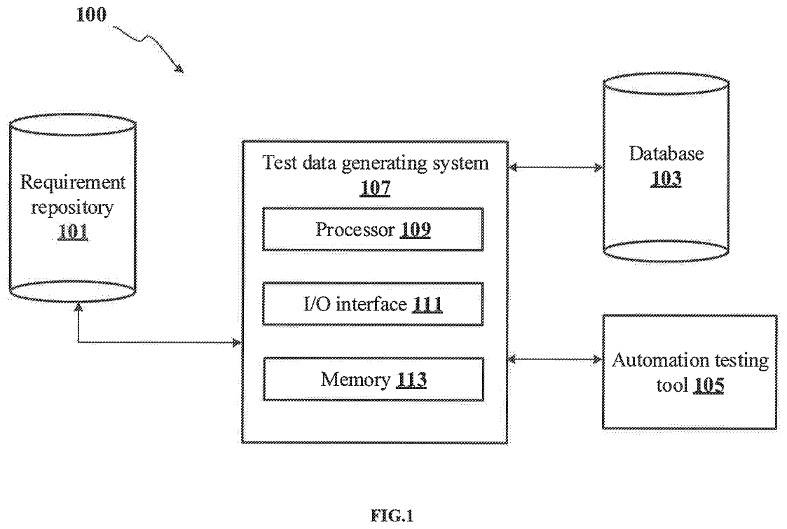

FIG. 1 shows an exemplary architecture for automating generation of test data and associated configuration data for testing, in accordance with some embodiments of the present disclosure.

The architecture 100 includes a requirement repository 101, a database 103, an automation testing tool 105 and a test data generating system 107. The requirement repository 101 may include, but not limited to, test requirement data. In some embodiments, the test requirement data may be retrieved from a test plan related to an Application Under Test (AUT). The test plan is generally a document detailing objectives, resources, and processes for testing a software or a hardware product. In other words, the test plan provides a strategy that will be used to verify and ensure that a product or a system meets its design specifications and other requirements. The test requirement data may include one or more requirements for testing the AUT. In some embodiments, the requirement repository 101 may be associated with the test data generating system 107 via a communication network (not shown in the FIG. 1). As an example, the communication network may be a wired communication network or a wireless communication network. Further, the database 103 may include, but not limited to, plurality of automation modules. The plurality of automation modules may be configured to perform a plurality of actions. In some embodiments, the plurality of actions performed by the plurality of automation modules may include, but not limited to, generating test data and associated configuration data required for testing. In some embodiments, the plurality of automation tools may be installed via a docker container which is a lightweight, open platform technology for developing, building, shipping and running distributed applications. The docker container may be a standardized container enabling a software application to run across one or more platforms. The docker container may contain the necessary resources to run a software application and encapsulates services in isolated environments called containers. The docker container may allow user to create multiple isolated and secure environments within a single instance of an operating system.

Further, the automation testing tool 105 may be associated with the test data generating system 107 via the communication network. In some embodiments, the automation testing tool 105 may be configured within the test data generating system 107. In some embodiments, the automation testing tool 105 may be configured to execute one or more test scenarios based on the test data and the associated configuration data generated by the test data generating system 107. In some embodiments, the one or more test scenarios may be related to the test requirement data. As an example, the one or more test scenarios may be functional test scenarios and regression test scenarios.

Further, the test data generating system 107 may be hosted on a server. In some embodiments, the server may be a local server, cloud server or a remote server. Further, the test data generating system 107 includes a processor 109, an Input/Output (I/O) interface 111 and a memory 113. In some embodiments, the processor 109 may retrieve the test requirement data from the test plan related to the AUT and store the test requirement data in the requirement repository 101. In some other embodiments, the processor 109 may retrieve the test requirement data directly from the requirement repository 101. Further, the processor 109 may translate the test requirement data into a plurality of vectors. In some embodiments, the processor 109 may provide each of the plurality of vectors as input to a trained Artificial Neural Network (ANN) module to identify a context associated with the plurality of vectors based on a plurality of probabilities generated for each of the plurality of vectors. In some embodiments, the plurality of probabilities is generated by the trained ANN using the input. Further, the processor 109 may select at least one automation module from the plurality of automation modules based on the context. Upon selecting the at least one automation module, the processor 109 may execute the at least one automation module to generate the test data and the associated configuration data for testing.

Further, the processor 109 may provide the generated test data and the associated configuration data to the automation testing tool 105 for executing the one or more test scenarios. In some embodiments, the test data generating system 107 may retrieve the one or more test scenarios related to the test requirement data from one or more data sources (not shown in the FIG. 1). As an example, the one or more data sources may include, but not limited to, a test management tool and a test scenario repository. Upon executing the one or more test scenarios, the processor 109 may monitor time taken for execution of the one or more test scenarios and validate performance corresponding to execution of the one or more test scenarios by comparing the time taken for execution of the one or more test scenarios with a predefined standard execution time.

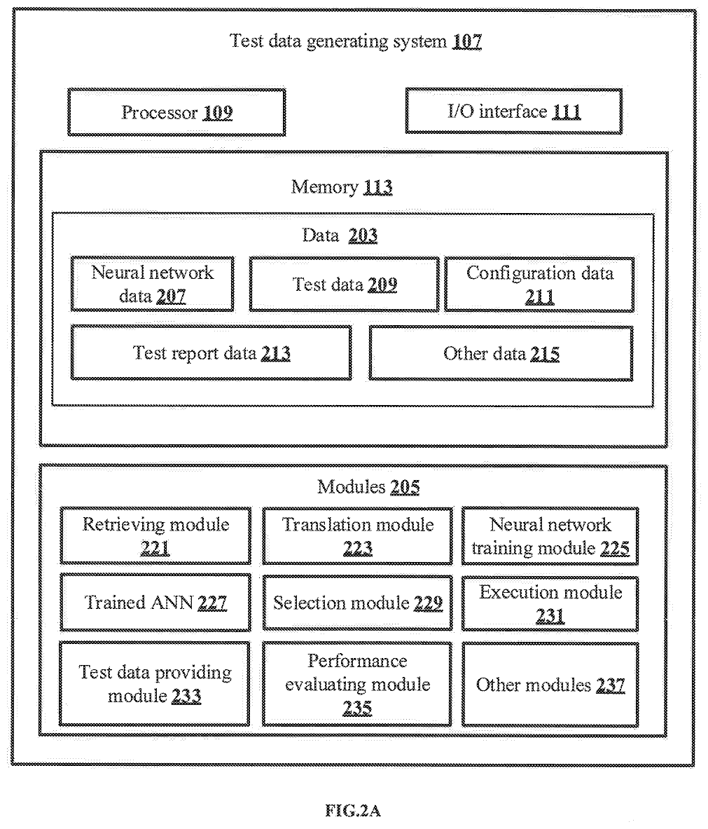

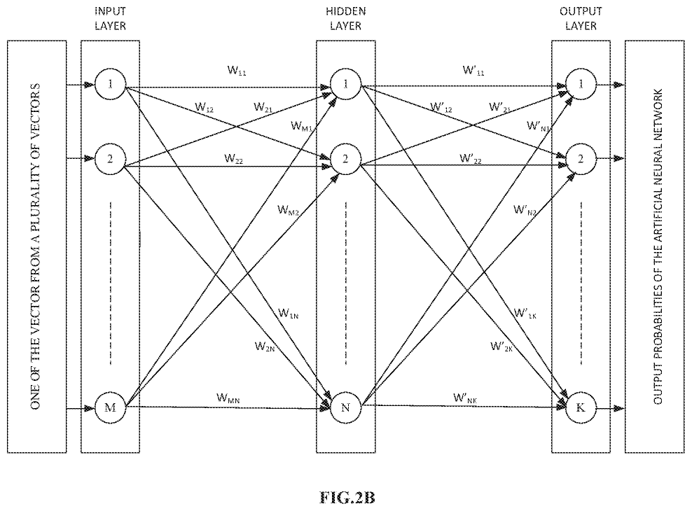

FIG. 2A shows a detailed block diagram of a test data generating system, in accordance with some embodiments of the present disclosure.

In some implementations, the test data generating system 107 may include data 203 and modules 205. As an example, the data 203 may be stored in a memory 113 configured in the test data generating system 107 as shown in the FIG. 2A. In one embodiment, the data 203 may include neural network data 207, test data 209, configuration data 211, test report data 213 and other data 215. In the illustrated FIG. 2A, modules 205 are described herein in detail.

In some embodiments, the data 203 may be stored in the memory 113 in form of various data structures. Additionally, the data 203 can be organized using data models, such as relational or hierarchical data models.

In some embodiments, the neural network data 207 may include a plurality of weights between an input layer and one or more hidden layers and between the one or more hidden layers and an output layer. Further, the neural network data 207 may include an activation function data for the one or more hidden layers and output layer. As an example, the activation function data for the one or more hidden layers may be a linear activation function. As an example, the activation function data for the output layer may be a SoftMax function which may be represented using the below

$$\begin{matrix}Equation 1 & \\ y i = \frac{{e}^{xi}}{{\sum }_{i = 0}^{n} {e}^{xi}} i = 0 , 1 , 2 … k & Equation 1\end{matrix}$$

In the above Equation 1,
yi indicates the output of the SoftMax function corresponding to the input element xi;
xi indicates each element of the input vector x. In some embodiments, the input vector xi may be fed to the one or more hidden layers or the output layer of the artificial neural network;
k indicates the number of elements in the vector x.

In some embodiments, all the outputs “yi” of the SoftMax function may be stored as vector y.

In some embodiments, the test data 209 may be data used at the time of execution of one or more test scenarios. As an example, attributes such as fund, username, password, trade type, policy type and the like may be considered as the test data 209.

In some embodiments, the configuration data 211 may be data that provides different set up before the execution of the one or more test scenarios using the test data 209. As an example, attributes such as flags, region, downstream enable/disable, access level and the like may be considered as the configuration data 211.

In some embodiments, the test report data 213 may include plurality of test reports related to execution of the one or more test scenarios using the test data 209 and the associated configuration data 211. In some embodiments, the plurality of test reports may include, but not limited to, performance results, test execution status (success or failure), test execution statistics, and the like. The test execution statistics may include number of test scenarios executed, the number of test scenarios passed, the number of test scenarios failed, pass percentage of test scenarios, fail percentage of the test scenarios and the like. Further, the test report data 213 may include information for example total number of bugs, status of bugs (open, closed, responding), number of bugs in open status, resolved status and closed status and the like.

In some embodiments, the other data 215 may include update equations for the plurality of weights for the Artificial Neural Network (ANN) and format details to store the test report data 213. Further, the other data 215 may store data, including temporary data and temporary files, generated by the modules 205 for performing the various functions of the test data generating system 107.

In some embodiments, the data 203 stored in the memory 113 may be processed by the modules 205 of the test data generating system 107. The modules 205 may be stored within the memory 113. In an example, the modules 205 communicatively coupled to the processor 109 configured in the test data generating system 107, may also be present outside the memory 113 as shown in FIG. 2A and implemented as hardware. As used herein, the term modules 205 may refer to an application specific integrated circuit (ASIC), a FPGA (Field Programmable Gate Array), an electronic circuit, a processor (shared, dedicated, or group) and memory that execute one or more software or firmware programs, a combinational logic circuit, and/or other suitable components that provide the described functionality. In some other embodiments, the modules 205 may be implemented using at least one of ASICs and FPGAs.

In some embodiments, the modules 205 may include, for example, a retrieving module 221, a translation module 223, a neural network training module 225, trained ANN 227, a selection module 229, an execution module 231, a test data providing module 233, a performance evaluating module 235 and other modules 237.

In some embodiments, the retrieving module 221 may retrieve a test requirement data from a test plan related to an Application Under Test (AUT). The test requirement data may include one or more requirements for testing the AUT. In some embodiments, the test requirement data may be retrieved directly from a requirement repository 101 associated with the test data generating system 107.

In some embodiments, the translation module 223 may be used to translate the test requirement data into a plurality of vectors. The translation module 223 may receive the test requirement data in a text format. Initially, the translation module 223 may remove stop words in the test requirement data. In some embodiments, the stop words may be one or more words which do not contribute to context of the test requirement data or meaning of the test requirement data. As an example, in English language the stop words may include “the”, “an”, “is”, “a”, “are”, “in” and the like. Further, the translation module 223 may convert the test requirement data into a vector using a word to vector model. In some embodiments, the word to vector model is a technique to represent a word in text format as vectors comprising numbers. In some embodiments, one-hot encoded vector may be used to represent the text in the test requirement data as a plurality of binary vectors. The one hot encoded vector may include words in the test requirement data mapped as integer values and each integer value may be represented as the plurality of binary vectors i.e. all zero values except the index of the integer, which is marked with one. For example, consider a test requirement data after removal of the stop words as “Trade valuation process validation”. This means that the translation module 223 identified a total of 4 words in the test requirement data as contributors to the context, hence integer values of 1 for “Trade”, 2 for “Valuation”, 3 for “Process” and 4 for “Validation” may be assigned.

Further, the translation module 223 may assign a binary vector for each integer to represent the text into a first set of vectors. Therefore, “Trade” may be represented as [1 0 0 0], “Valuation” may be represented as [0 1 0 0], “Process” may be represented as [0 0 1 0] and “Validation” may be represented as [0 0 0 1]. Likewise, different word to vector models (frequency based, predictions based, and the like) can be used.

In an embodiment, the neural network training module 225 may be used to train the Artificial Neural Network (ANN) based on a supervised learning algorithm using historical test requirement data as input and contents of a database 103 i.e. the plurality of automation modules associated with the test data generating system 107 as expected output. In some embodiments, the neural network training module 225 may provide the plurality of vectors generated by translating the test requirement data as an input to the ANN. Further, the neural network training module 225 may determine an error in the output generated by the ANN by comparing the output generated by the ANN with the expected or desired output. Based on the determined error and the type of supervised learning algorithm being used for training, the neural network training module 225 may modify or update plurality of weights associated with the ANN. The plurality of weights thus assigned may be stored as the neural network data 207.

As an example, consider E denotes the determined error of the ANN. Further, consider the supervised learning algorithm “back-propagation” is used for modifying the plurality of weights. Each weight (w) among the plurality of weights may be updated using the below

$$\begin{matrix}Equation 2 & \\ w = w - η * \frac{dE}{dw} & Equation 2\end{matrix}$$

Where η denotes the learning rate of the artificial neural network,

$$\frac{dE}{dw}$$

denotes the gradient of the determined error. In an embodiment, the plurality of the weights may be updated multiple times for the plurality of vectors generated by translating the test requirement data. Further, the neural network training module 225 may train the ANN based on execution status of the one or more test scenarios.

Further, the processor 109 may provide the plurality of vectors as input to the trained ANN 227. The trained ANN 227 may use the input to generate a plurality of probabilities for each of the plurality of vectors. The plurality of probabilities may be values which indicate a probability that each of the plurality of vectors are proximal to an input vector. By attempting to predict the probability, proximity of each of the plurality of vectors to one another, the trained ANN 227 may inherently learn relationship between words in the test requirement data. Further, the trained ANN 227 may identify a context associated with the plurality of vectors based on the plurality of probabilities generated for each of the plurality of vectors. In some embodiments, the context identified by the trained ANN 227 may correspond to at least one automation module among the plurality of automation modules which is best suited for the test requirement data. In an exemplary embodiment, the context of the plurality of vectors may be identified based on the highest probability among the plurality of probabilities. As an example, consider the number of outputs i.e. the number of probabilities generated by the trained ANN 227 is equal to the number of automation modules stored in the database 103. As an example, consider there are 5 automation modules stored in the database 103 and consider the output generated by the trained ANN 227 is [0.1 0.1 0.7 0.05 0.05]. In such scenarios, the trained ANN 227 may identify the context based on the highest probability among the plurality of probabilities. The selection module 229 may select the third automation module having the highest probability of 0.7 among the 5 automation modules stored in the database 103 for generating the test data 209 and the associated configuration data 211. The name of the third automation module thus selected may be the context of the plurality of vectors.

In some embodiments, the selection module 229 may select the at least one automation module from a plurality of automation modules stored in the database 103 based on the identified context. As an example, if the identified context is “Insurance Claim”, the automation module among the plurality of automation modules having the name “insurance claim” may be selected for further execution.

In some embodiments, the execution module 231 may execute the at least one automation module to generate the test data 209 and the associated configuration data 211 for testing.

In some embodiments, a test data providing module 233 may provide the generated test data 209 and the associated configuration data 211 to an automation testing tool 105 associated with the test data generating system 107. In some embodiments, the automation testing tool 105 may execute the one or more test scenarios using the generated test data 209 and the associated configuration data 211. In some embodiments, the one or more test scenarios related to the test requirement data may be retrieved by the processor 109 from one or more data sources and may provide the one or more test scenarios to the automation testing tool 105.

In some embodiments, a performance evaluating module 235 may monitor time taken for execution of the one or more test scenarios using the generated test data 209 and the associated configuration data 211. Upon monitoring the time taken, the performance evaluating module 235 may validate performance corresponding to execution of the one or more test scenarios by comparing the time taken for execution of the one or more test scenarios with a predefined standard execution time. Further, the monitored and validated performance of the execution of the one or more test scenarios may be used by the neural network training module 225 to further train the ANN.

In some embodiments, the performance evaluating module 235 may further generate a plurality of test reports based on the validation. In some embodiments, the plurality of test reports may include at least one of performance results, test execution status, and test execution statistics. As an example, the plurality of test reports may be in a Comma Separate Values (CSV) format.

In some embodiments, the other modules 237 may be used to perform various miscellaneous functionalities of the test data generating system 107. It will be appreciated that such aforementioned modules 205 may be represented as a single module or a combination of different modules.

Further, in some embodiments, the trained ANN 227 may internally develop a knowledge based with year's worth of test data 209 and the corresponding configuration data 211, corresponding test cases/scenarios/requirements/stories and other related information. The trained ANN 227 may further apply the information present in the knowledge base to predict the test data 209 and corresponding configuration data 211 for new test scenarios effectively. Further, the trained ANN 227 may also decide on when and where new automation modules need to be created based on the knowledge base.

Further, in some embodiments, the test data generating system 107 may process multiple scenario execution based on the different sets of real time data to achieve Cross Functional Coverage. The real time data may be fed as input to a configuration setup, which results in configured real time data. The result thus obtained may be passed on to next sequence i.e. to execute one or more test scenarios. The result of the execution of the one or more test scenarios may be generated in terms of a report format indicating status of the result.

The present disclosure is explained below with an exemplary scenario. However, this should not be construed as a limitation of the present disclosure.

In an exemplary embodiment, the ANN as shown in FIG. 2B, may include, one input layer, one hidden layer and one output layer. In another embodiment, a plurality of hidden layers may be present in the ANN. For the purpose of illustration, the present disclosure is explained considering a single hidden layer. In some embodiments, the input layer may be configured to receive the plurality of vectors for which probability has to be determined. In some embodiments, the probability indicates a prediction related to proximity of words in the test requirement data to an input word. Further, the hidden layer may be configured to assign weights such that error on the prediction of the probability is minimized. Furthermore, the output layer is configured to provide a probability of proximity of the words in the test requirement data to the input word based on the weights assigned by the hidden layer, as output.

In some embodiments, the input layer may be provided with the plurality of vectors as input. In some embodiments, number of neurons in the input layer may be equal to number of values in the plurality of vectors. Further, the output of the input layer may be same as the input to the input layer. Using the identity function as the activation function, i.e., the input layer may receive the one or more vectors and forward the one or more vectors to the hidden layer. The activation function of the hidden layer is a linear activation and the activation function for the output layer is a SoftMax function.

As shown in the FIG. 2B, the input layer may be represented by a one-hot encoded vector x of dimension V, where V is the size of the words of the test requirement data. Further, the hidden layer may be defined by a vector of dimension N and the output layer may be defined by a vector of dimension V.

Further, the weights assigned between the input layer and the hidden layer may be represented by a matrix W, of dimension V×N. Similarly, the weights assigned between the hidden layer and the output layer may be represented by a matrix W′, of dimension N×V. As an example, as shown in the FIG. 2B, relationship between an element x of the input layer and an element h of the hidden layer is represented by the weight W. Similarly, relationship between the element h of the hidden layer and an element y of the output layer is represented by the weight W′. Further, the output vector y will be compared against the expected targets y\hat{ }(Expected output). Closest the output vector y is to y\hat{ }, better is the performance of the ANN and the lower is the loss function.

As an example, consider the a test requirement data after removal of the stop words as “Trade valuation process validation”. Therefore, size of the words of the test requirement data “V” is 4. For each word in the test requirement data, a target word is determined as shown in the below Table 1.

TABLE 1

| Training example | Input word | Target word |
|---|---|---|
| 1 | Trade | valuation |
| 2 | Valuation | process |
| 3 | Process | validation |

To feed the above words to the ANN, the words need to be transformed into vectors. As an example, consider a one-hot encoding method is used for converting the words into vectors. Therefore, word “Trade” may be represented as [1 0 0 0], word “Valuation” may be represented as [0 1 0 0], word “Process” may be represented as [0 0 1 0] and word “Validation” may be represented as [0 0 0 1].

Therefore, the Table 1 may now be transformed into Table 2 as shown below:

TABLE 2

| Training example | Input word | Target word |
|---|---|---|
| 1 | [1 0 0 0] | [0 1 0 0] |
| 2 | [0 1 0 0] | [0 0 1 0] |
| 3 | [0 0 1 0] | [0 0 0 1] |

In some embodiments, the target word represent the ideal prediction from the ANN for a given input word. Consider, ANN is being trained using the input word “Trade”, the target word should be “Valuation” according to the Table 1. Therefore, ideally, values of the weights should be such that when the input x=[1,0,0,0]—which corresponds to the word “Trade” are given, the output should be close to y\hat{ }=[0,1,0,0]—which corresponds to the word “Valuation”

Upon assigning the initial weights, values of the hidden layer are determined and thereafter values of the output layer are determined. The output of the hidden layer (denoted as h) may be computed using the below Equation 3:

h=W^{T}*X Equation 3

In the above Equation 3,

h denotes value of the hidden layer;

W denotes weight of neuron-Input layer to hidden layer; and

x denotes input value.

Further, the output of the output layer (denoted as u) may be computed using the below Equation 4:

u=W′^{T}*h Equation 4

In the above Equation 4,

u denotes value of the output layer;

W′ denotes weight of neuron-hidden layer to output layer; and

h denotes value of the hidden layer.

Upon applying SoftMax function to the output value “u”, the final output value y is given by the below Equation 5.

y=SoftMax(u) Equation 5

As an example, consider the final output value “y” is as shown below:

$$[ \begin{matrix}0.052565 \\ 0.7445479 \\ 0.0698755 \\ 0.13301083\end{matrix} ]$$

The value of “y” evidently has an error when compared to the desired output value [0 1 0 0]. Therefore, to minimize the error, the ANN may be trained to determine an error (denoted as E) between the output generated by the ANN and the desired output may be computed using the Equation 6 as given below:

E=log(E(Y₁)+E(Y₂)+ . . . +E(Y_{K})) Equation 6

In the above Equation 6, E(Yᵢ) may be computed using the below Equation 7:

E(Yᵢ)=(log(e^{U1}+e^{U2}+ . . . +e^{UK})−U4) Equation 7

In an exemplary embodiment, the error E may be minimized using a gradient descent technique in the back-propagation algorithm by modifying the plurality of weights (W and W′) so that the accuracy of the output of the ANN improves. To modify the plurality of weights (W and W′) the derivatives are computed and the plurality of weights (W and W′) are updated as shown in the below Equations 8 and 9:

$$\begin{matrix}w = w - η * \frac{dE}{dw} & Equation 8 \\ {w}^{′} = {w}^{′} - η * \frac{dE}{{dw}^{′}} & Equation 9\end{matrix}$$

In the above Equations 8 and 9,

$$\frac{dE}{dw} = A ⊗ ( {W}^{′} * E ) and$$

$$\frac{dE}{{dw}^{′}} = ( {W}^{T} * X ) ⊗ E ,$$

where ⊗ denotes the outer product of the matrices.

In this manner, the ANN may determine the accurate weights and thereby provide the plurality of probabilities by comparing each word in the test requirement data with the input word, to identify the context. Based on the context, the test data generating system 107 may select at least one automation module among the plurality of automation modules to generated the test data 209 and the corresponding configuration data 211.

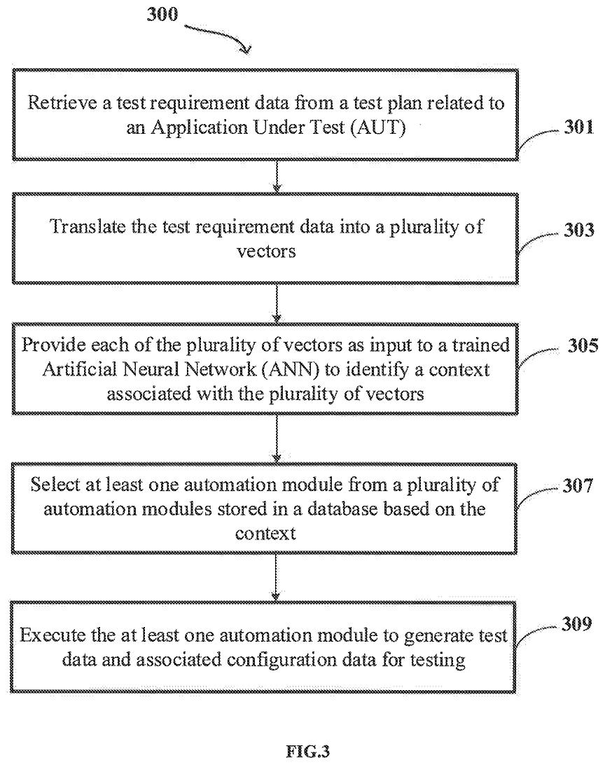

FIG. 3 shows a flowchart illustrating a method of automating generation of test data and associated configuration data for testing in accordance with some embodiments of the present disclosure.

As illustrated in FIG. 3, the method 300 includes one or more blocks illustrating a method of automating generation of test data 209 and associated configuration data 211 for testing. The method 300 may be described in the general context of computer-executable instructions. Generally, computer-executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include retrieving, by a processor 109 of the test data generating system 107, a test requirement data from a test plan related to an Application Under Test (AUT). In some embodiments, the test requirement data may be in a text format.

At block 303, the method 300 may include translating, by the processor 109, the test requirement data into a plurality of vectors. In some embodiments, the test requirement data may be translated into the first set of vectors based on a word to vector model.

At block 305, the method 300 may include providing, by the processor 109, each of the plurality of vectors as input to a trained Artificial Neural Network (ANN) 227 to identify a context associated with the plurality of vectors based on a plurality of probabilities generated for each of the plurality of vectors.

At block 307, the method 300 may include selecting, by the processor 109, at least one automation module from a plurality of automation modules stored in a database 103 associated with the test data generating system 107 based on the identified context.

At block 309, the method 300 may include executing, by the processor 109, the at least one automation module to generate test data 209 and associated configuration data 211 for testing. In some embodiments, the processor 109 may provide the generated test data 209 and associated configuration data 211 to an automation testing tool 105 associated with the test data generating system 107 for executing one or more test scenarios. Upon executing the one or more test scenarios based on the test data 209 and associated configuration data 211, the processor 109 may monitor time taken for execution of the one or more test scenarios and further may validate performance corresponding to execution of the one or more test scenarios by comparing the time taken for execution of the one or more test scenarios with a predefined standard execution time. Based on the monitoring and the validation, the processor 109 may generate a plurality of test reports. In some embodiments, the plurality of test reports comprises at least one of performance results, test execution status, and test execution statistics

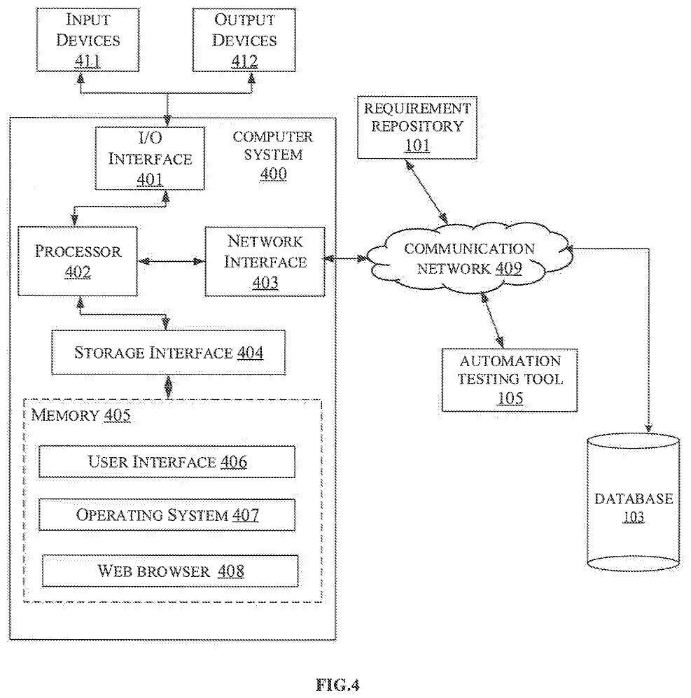

FIG. 4 is a block diagram of an exemplary computer system for implementing embodiments consistent with the present disclosure.

In some embodiments, FIG. 4 illustrates a block diagram of an exemplary computer system 400 for implementing embodiments consistent with the present invention. In some embodiments, the computer system 400 can be test data generating system 107 that is used for automating generation of test data 209 and associated configuration data 211 for testing. The computer system 400 may include a central processing unit (“CPU” or “processor”) 402. The processor 402 may include at least one data processor for executing program components for executing user or system-generated business processes. The processor 402 may include specialized processing units such as integrated system (bus) controllers, memory management control units, floating point units, graphics processing units, digital signal processing units, etc.

The processor 402 may be disposed in communication with input devices 411 and output devices 412 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the computer system 400 may communicate with the input devices 411 and the output devices 412.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with a requirement repository 101, a database 103 and an automation testing tool 105. The communication network 409 can be implemented as one of the different types of networks, such as intranet or Local Area Network (LAN), Closed Area Network (CAN) and such. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some embodiments, the computer system 400 may store user/application data, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP6, VISTA®/7/8, 10 etc.), APPLE® IOS®, GOOGLE™ ANDROID®, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scrollers, windows, widgets, etc. Graphical User Interfaces (GUIs) may be employed, including, without limitation, Apple Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flashe, etc.), or the like.

In some embodiments, the computer system 400 may implement the web browser 408 stored program components. The web browser 408 may be a hypertext viewing application, such as MICROSOFT® INTERNET EXPLORER®, GOOGLE™ CHROME™, MOZILLA® FIREFOX®, APPLE® SAFARI, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for automating generation of test data and associated configuration data for testing. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

Referral numerals

| Reference | |
|---|---|
| Number | Description |
| 100 | Architecture |
| 101 | Requirement repository |
| 103 | Database |
| 105 | Automation testing tool |
| 107 | Test data generating system |
| 109 | Processor |
| 111 | I/O interface |
| 113 | Memory |
| 203 | Data |
| 205 | Modules |
| 207 | Neural network data |
| 209 | Test data |
| 211 | Configuration data |
| 213 | Test report data |
| 215 | Other data |
| 221 | Retrieving module |
| 223 | Translation module |
| 225 | Neural network training module |
| 227 | Trained ANN |
| 229 | Selection module |
| 231 | Execution module |
| 233 | Test data providing module |
| 235 | Performance evaluating module |
| 237 | Other modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User interface |
| 407 | Operating system |
| 408 | Web browser |
| 409 | Communication network |
| 411 | Input devices |
| 412 | Output devices |

What is claimed is:

1. A method of automating generation of test data and associated configuration data for testing, the method comprising:
retrieving, by a test data generating system, a test requirement data from a test plan related to an Application Under Test (AUT);
translating, by the test data generating system, the test requirement data into a plurality of vectors;
providing, by the test data generating system, each of the plurality of vectors as input to a trained Artificial Neural Network (ANN) to identify a context associated with the plurality of vectors based on a plurality of probabilities generated for each of the plurality of vectors, wherein the plurality of probabilities are generated by the trained ANN using the input;
selecting, by the test data generating system, at least one automation module from a plurality of automation modules stored in a database based on the context; and
executing, by the test data generating system, the at least one automation module to generate test data and associated configuration data for testing.

2. The method as claimed in claim 1, wherein translating the test requirement data into the plurality of vectors is based on a word to vector model.

3. The method as claimed in claim 1, wherein the ANN is trained based on a supervised learning algorithm using historical test requirement data as input and the plurality of automation modules as expected output.

4. The method as claimed in claim 1 further comprising providing, by the test data generating system, the generated test data and the associated configuration data to an automation testing tool associated with the test data generating system for executing one or more test scenarios.

5. The method as claimed in claim 4 further comprising:
monitoring, by the test data generating system, time taken for execution of the one or more test scenarios; and
validating, by the test data generating system, performance corresponding to execution of the one or more test scenarios by comparing the time taken for execution of the one or more test scenarios with a predefined standard execution time.

6. The method as claimed in claim 5 further comprising generating, by the test data generating system, a plurality of test reports based on the validation, wherein the plurality of test reports comprises at least one of performance results, test execution status, and test execution statistics.

7. The method as claimed in claim 1, wherein the ANN is further trained based on a plurality of test reports.

8. A test data generating system for automating generation of test data and associated configuration data for testing, the test data generating system comprising:
a processor; and
a memory communicatively coupled to the processor, wherein the memory stores the processor-executable instructions, which, on execution, causes the processor to:
retrieve a test requirement data from a test plan related to an Application Under Test (AUT);
translate the test requirement data into a plurality of vectors;
provide each of the plurality of vectors as input to a trained Artificial Neural Network (ANN) to identify a context associated with the plurality of vectors based on a plurality of probabilities generated for each of the plurality of vectors, wherein the plurality of probabilities are generated by the trained ANN using the input;
select at least one automation module from a plurality of automation modules stored in a database based on the context; and
execute the at least one automation module to generate test data and associated configuration data for testing.

9. The test data generating system as claimed in claim 8, wherein the processor translates the test requirement data into the plurality of vectors based on a word to vector model.

10. The test data generating system as claimed in claim 8, wherein the processor trains the ANN based on a supervised learning algorithm using historical test requirement data as input and the plurality of automation modules as expected output.

11. The test data generating system as claimed in claim 8, wherein the processor is further configured to provide the generated test data and the associated configuration data to an automation testing tool associated with the test data generating system for executing one or more test scenarios.

12. The test data generating system as claimed in claim 11, wherein the processor is further configured to:
monitor time taken for execution of the one or more test scenarios; and
validate performance corresponding to execution of the one or more test scenarios by comparing the time taken for execution of the one or more test scenarios with a predefined standard execution time.

13. The test data generating system as claimed in claim 12, wherein the processor is further configured to generate a plurality of test reports based on the validation, wherein the plurality of test reports comprises at least one of performance results, test execution status, and test execution statistics.

14. The test data generating system as claimed in claim 8, wherein the processor is configured to further train the ANN based on a plurality of test reports.

15. A non-transitory computer readable medium including instructions stored thereon that when processed by at least one processor causes a test data generating system to perform operations comprising:
retrieving a test requirement data from a test plan related to an Application Under Test (AUT);
translating the test requirement data into a plurality of vectors;
providing each of the plurality of vectors as input to a trained Artificial Neural Network (ANN) to identify a context associated with the plurality of vectors based on a plurality of probabilities generated for each of the plurality of vectors, wherein the plurality of probabilities are generated by the trained ANN using the input;
selecting at least one automation module from a plurality of automation modules stored in a database based on the context; and
executing the at least one automation module to generate test data and associated configuration data for testing.
